(19) United States
(12) Patent Application Publication
(10) Pub. No.: US 2002/0196704 A1
(43) Pub. Date: Dec. 26, 2002

(54) Perforated-plate churn-mixer

(76) Inventor: Douglas L. May, Huntsville, AL (US)

Correspondence Address: Legal Office, (AMSAM-L-G-I, Mr. Fred M. Bush), US Army Aviation and Missile Command, Redstone Arsenal, AL, 35898-5000, US

(21) Appl. No.: 09/893,017

(22) Filed: Jun. 26, 2001

(51) Int. Cl. B01F 13/00

(52) U.S. Cl. 366/256

(57) ABSTRACT

A Perforated-Plate Churn-Mixer (PPCM) is disclosed for a mixing system that is used to efficiently wet and disperse small-particle-size solids into a liquid and then provide a wide range of shear levels to insure the break-up of any remaining agglomerates and the uniformity of the mixture. The PPCM is a device which comprises a mixing vessel and a perforated plate that oscillates within the vessel to force the solids and liquids to pass repeatedly through the perforations in the plate and the clearance between the plate and the walls of the vessel. The perforated plate is attached to a rod that is oscillated by external equipment and passes through an airtight seal in the lid of the vessel. The lid maintains an airtight seal with the parallel walls of the vessel and also has a vent that can be closed. The lid can be raised or lowered by external machinery to: 1) vary the mixer volume, 2) expel the gaseous volume above the mixture through the lid vent, and 3) expel the finished product through a valve in the bottom of the mixing vessel. The device provides high wetting efficiency by forcing the entire volume of unwetted solids and liquids by each cycle back and forth through and around the perforated plate until complete wetting and uniform dispersion are achieved.

### DEDICATORY CLAUSE

The invention described herein may be manufactured, used, and licensed by or for the Government for governmental purposes without the payment to me of any royalties thereon.

### BACKGROUND OF THE INVENTION

Making gels have been achieved since the 1970's with mixing technologies that consist of: 1) commercially available equipment, such as vertical mixers with dual planetary sigma-blades or multi-element, high-shear kettle mixers, and 2) common laboratory mixing glassware for small-scale batches, such as by rotating a paddle or propeller in a reaction kettle. These mixers can functionally disperse fluffy powders into a liquid and result in a fully mixed batch; however, they lack the efficiency and several desired features. A search for applicable mixing systems in the early 1990's resulted in the discovery of a Austrian manufacturer—Neulinger-Kreuziger (N-K)—that made a “Press-Mixer”—a system that might have met many mixing requirements; but N-K went out of business in about 1994. Their Press-Mixer had a variable-height, flat propeller-blade (with wiper edges) that rotated in a cylindrical vessel. Similar equipment might have been available through the company that bought the rights to the Press-Mixer design (Voigt in Germany), but they had not started making them at the time.

An object of this invention is to provide a design of a mixing system that could meet all mixing requirements. These mixing system requirements include:

the ability to disperse homogeneously sub-micron solids within liquids that may be flammable, corrosive, toxic, and/or volatile;

any ingredient additions throughout the process must not allow exposure to the environment;

the system must fully retain any desirable volatile components but allow pressure-relief of any reaction gases;

the process must be able to handle effectively variable batch volumes;

the process and mixing vessel must accommodate solids with very low bulk densities very “fluffy” with interstitial air;

the process must not retain any kind of gas within the completed gel, including air or purge gases, reaction gases, or vaporized volatiles;

the process must wet all solids and complete any gassing before increasing gellation viscosities preclude escape of the bubbles;

the mixing system must control batch temperatures between 40 and +60° C. with ±1° C. precision; and,

the completed gel must be able to be expelled directly into an attachable receiving tank (the completed batch must not be exposed to the environment).

### SUMMARY OF THE INVENTION

A Perforated-Plate Churn-Mixer (PPCM) is a device that is provided in a mixing system that can be used to efficiently wet and disperse small-particle-size solids into a liquid and then provide a wide range of shear levels to insure the break-up of any remaining agglomerates and the uniformity of the mixture. The device comprises a mixing vessel and a perforated plate that oscillates within the vessel to force the solids and liquids to pass repeatedly through the perforations in the plate and the clearance between the plate and the walls of the vessel. The perforated plate is attached to a rod that is oscillated by external equipment and passes through an airtight seal in the lid of the vessel. The lid maintains an airtight seal with the parallel walls of the vessel and also has a vent that can be closed. The lid can be raised or lowered by external machinery to: 1) vary the mixer volume, 2) expel the gaseous volume above the mixture through the lid vent, and 3) expel the finished product through a valve in the bottom of the mixing vessel. The device provides high wetting efficiency by forcing the entire volume of unwetted solids and liquids to be affected by each cycle of the perforated plate. The flow of the unmixed components can be cycled back and forth through and around the perforated plate until complete wetting and uniform dispersion are achieved.

### BRIEF DESCRIPTION OF THE DRAWINGS

FIG. 1 of the drawing depicts a perforated-plate chum-mixer and associated elements to teach the operational description of the mixer.

FIG. 2a depicts the configuration to add solids to the mixer.

FIG. 2b depicts the configuration to add liquids to the mixer.

FIG. 2c depicts the configuration to depict the valve in the valve port in an open position to allow the liquid material to enter the mixing vessel solids to the mixer

FIG. 2d depicts the configuration for a wetting phase of the mixing procedure to accommodate a wide range of ingredients.

FIG. 2e depicts the configuration for expulsion of the gaseous volume above the batch being mixed.

FIG. 2f depicts the configuration for mixing and shearing phase of the procedure.

FIG. 2g depicts the perforated plate placed in the highest position within the mixed volume-contacting the follower-lid.

FIG. 2h depicts the configuration for expulsion of the batch from the mixer in an efficient manner by slowly lowering the follower-lid and the perforated plate ahead of it until the perforated plate and the follower-head are at the bottom of the mixing vessel.

### DESCRIPTION OF THE PREFERRED EMBODIMENT(s)

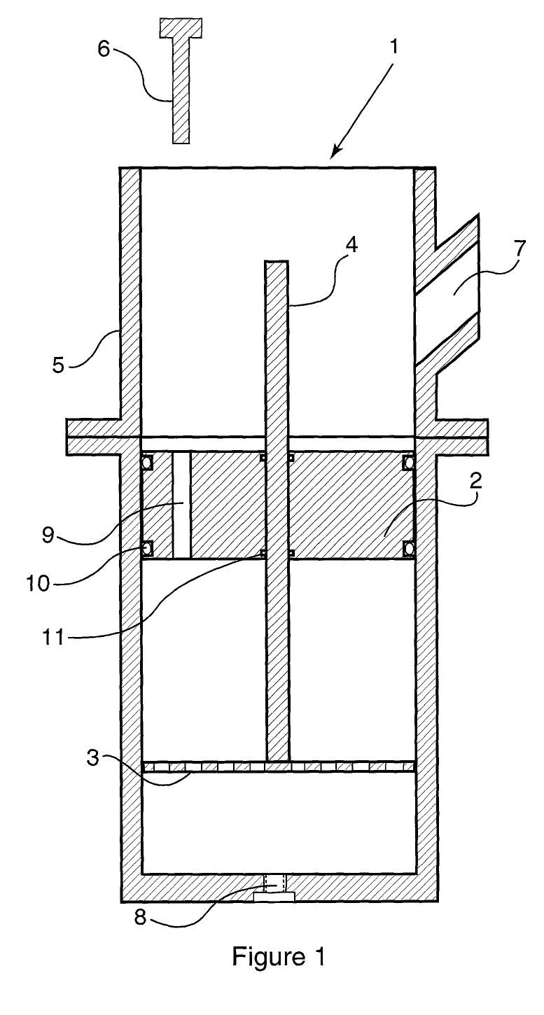

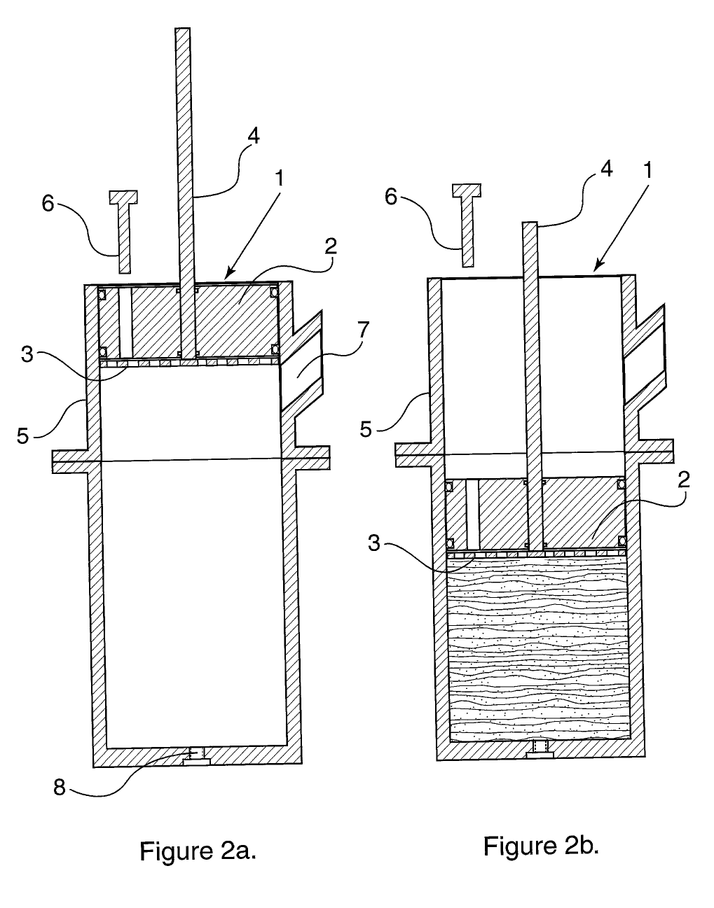

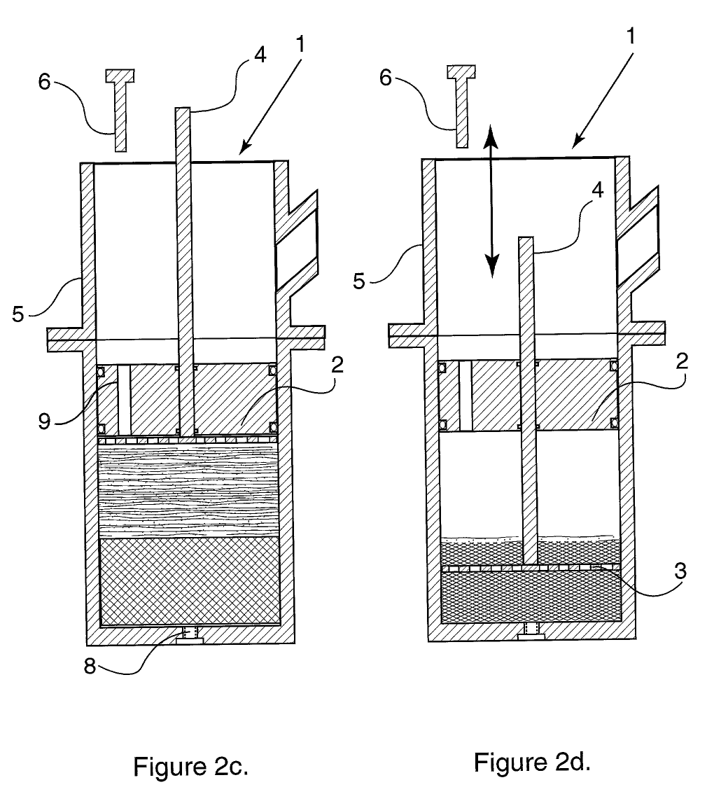

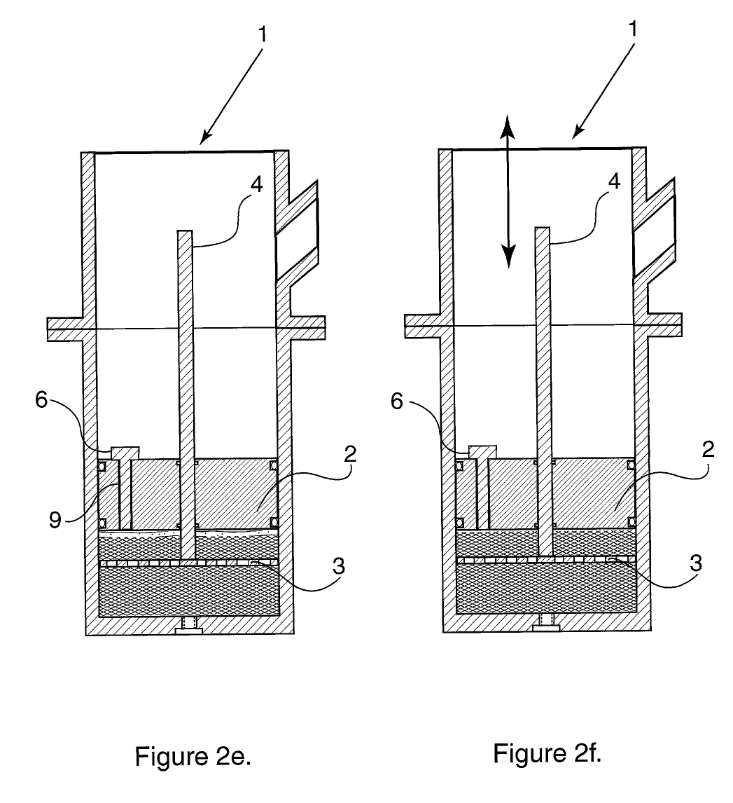

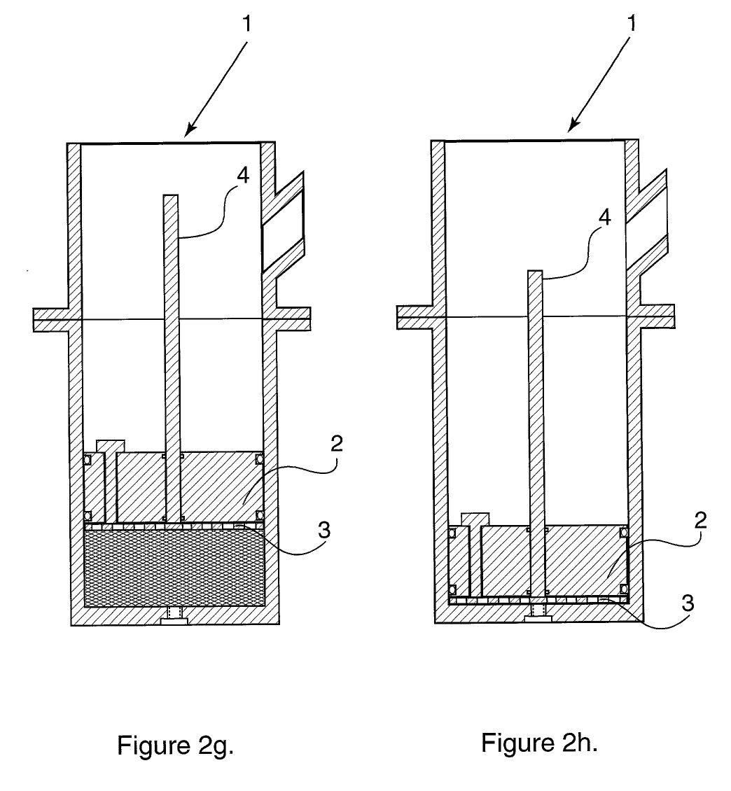

In further reference to the Figures of the Drawing, FIG. 1 depicts the perforated-plate churn-mixer (PPCM)(1) comprising a follower-lid (2); and a perforated plate (3) attached to a movable rod (4). The follower-lid (2) maintains gas-tight seals with the walls of the (PPCM); i.e., mixing vessel (1) and the rod (4) because of the wall seals (10) and the rod seals (11), respectively. The mixer components and the seals must be compatible with the materials to be mixed. A lid guide-head (5) is depicted at the top of the (PPCM). A solids fill-port (7) is shown in the lid guide-head (5). A plug (6) for gas vent is shown in subsequent drawings FIGS. 2a.-2d. removed from the gas vent (9) extending through the follower-lid (2). Plug (6) for gas vent is shown in subsequent drawings FIGS. 2e.-2h.inserted in the gas vent (9) extending through the follower-lid (2). A valve port (8) for liquid filling and gel expelling is shown at the bottom of the (PPCM).

The operational description for the perforated-plate churn-mixer (PPCM) is described in conjunction with FIGS. 2a, 2b, 2c, 2d, 2e, 2f, 2g, and 2h wherein like numbers define like parts or elements of the (PPCM) for each of the Figures are shown with the functional description of the mixing steps. (a. through i.) set forth below as follows:

a. CONFIGURATION TO ADD SOLIDS TO THE MIXER—With a closed valve (not shown) in the valve port (8) at the bottom of the mixing vessel (1), and the lid guide-head (5) attached to and aligned with the top of the mixing vessel (1), the follower-lid (2) and the rod (4) with the perforated plate (3) are raised by external means to the top of the lid guide-head (5) so as to allow the addition of solid materials to the mixing vessel (1) through the solids fill-port (7). The follower-lid (2) maintains gas-tight seals with the walls of the mixing vessel (1) and the rod (4) because of the wall seals (10) and the rod seals (11), respectively. The mixer components and seals must be compatible with the materials to be mixed. Refer to FIG. 2a.

b. Solids are added to the mixing vessel (1) using the solids fill-port (7) in the lid guide-head (5).

c. CONFIGURATION TO ADD LIQUIDS TO THE MIXER—The follower-lid (2) and the rod (4) with the perforated plate (3) are lowered through the lid guide-head (5) and into the mixing vessel (1) so as to provide enough volume within the mixing vessel (1) to contain the added solids and the liquids yet to be added. Refer to FIG. 2b.

d. The valve in the valve-port (8) is opened to allow the liquid material, delivered by external means, to enter the mixing vessel (1). The rising liquid will begin to fill the interstitial spaces between the solid particles and cause some of the air to rise toward the top of the mixing vessel (1) and vent through the gas vent (9). If contact between the solids and the liquid cause a gassing reaction, then the vent can remain open during the wetting phase of the process; if no gassing occurs, then the plug (6) can now be inserted into the gas vent (9) in the follower-lid (2). to retain desirable volatiles in the batch, the use of a reflux condenser in the gas vent (9) can be used. Refer to FIG. 2c.

e. THE WETTING PHASE OF THE PROCEDURE—With the follower-lid (2) held in position by external means, the rod (4) and perforated plate (3) are cycled up and down by external means within the full volume of the mixing vessel (1), thus preventing any dead zones or unmixed regions in the batch. The oscillation speed and force can be adjusted to accommodate a wide range of ingredients. Refer to FIG. 2d.

f. EXPULSION OF THE GASEOUS VOLUME ABOVE THE BATCH—After the solids have been wetted and their interstitial air released (but prior to any significant thickening of the liquid or gelling action by the partly-dispersed solids), the gas vent (9) can be unplugged (if it was plugged for non-gassing materials) and the follower-lid (2) can be lowered slowly by external means to expel the gasses above the batch through the gas vent (9). This part of the procedure is more effective at removing the gasses if the perforated plate (3) is below the surface of the liquid. After the gasses are expelled, then the plug (6) is replaced prior to the mixing and shearing phase of the procedure. Refer to FIG. 2e.

g. THE MIXING AND SHEARING PHASE OF THE PROCEDURE—With the follower-lid (2) held in position by external means, the rod (4) and perforated plate (3) are again cycled up and down by external means within the full volume of the mixing vessel (1). The oscillation speed and force can be adjusted (both usually increased from wetting-phase levels for more effective mixing shear) to accommodate a wide range of ingredients. Refer to FIG. 2f.

h. After the mixing and shearing phase has broken up any agglomerated solids and completely and uniformly dispersed the solids within the liquid, the rod (4) with the perforated plate (3) is placed in the highest position within the mixed volume—contacting the follower-lid (2). The valve (not shown) in the valve port (8) at the bottom of the mixing vessel (1) is then opened to allow the expulsion of the mixed batch. Refer to FIG. 2g.

i. EXPULSION OF THE BATCH FROM THE MIXER—The batch is expelled efficiently from the mixer through valve port 8 by slowly lowering the follower-lid (2) by external means (simultaneously pushing the rod (4) and the perforated plate (3) ahead of it) until the perforated plate (3) and follower-lid (2) are at the bottom of the mixing vessel (1). The only batch residue (waste material) remaining in the mixing vessel (1) should be the gelled material left within the perforations and within the plate-to-wall clearance. Refer to FIG. 2h.

It is to be understood, therefore, that while the present invention has been described by specific examples, it should not be limited thereto, for obvious variations such as location of the valve port, which can be located at either end of the containment vessel without deviating from the spirit of the invention or the scope of the appended claims.

I claim:

1. A perforated-plate churn-mixer (PPCM) comprising:
(i) a perforated plate or disk, one or more shafts attached to the plate, and a containment vessel with a closure;
(ii) a perforated plate that can traverse the entire containment vessel, cycling back and forth or up and down, being bounded at each end by either the vessel or a closure;
(iii) a perforated plate having perforations that can vary in shape, size, number, layout pattern, and degree of edge chamber, to optimize the mixing action of the plate for the materials being mixed;
(iv) a perforated plate that cycles within the vessel with a variable stroke velocity to optimize mixing action of the plate for the materials being mixed;
(v) a containment vessel that has boundaries for the moving plate that conform to the shape of the plate, such that the only regions within the vessel that are not displaced by the motion of the plate are 1) the minimal clearance between the vessel walls and the outer edge of the perforated plate and 2) the space within the plate perforations;
(vi) a vessel closure that can act as a piston within the containment vessel and traverse the entire length of the containment vessel, forming a seal with the wall of the vessel, allowing 1) the operational volume of the containment vessel to vary and accommodate a range of batch sizes and 2) the expulsion of almost the entire contents of the containment vessel through a port in the vessel due to the conformal nature of the vessel and the perforated plate;

2. A method of employing a PPCM comprising:
(i) a wetting stage of the mixing operation that stimulates high-efficiency contact between the undispersed solid phase and the liquid phase, wherein the perforated plate is cycled repeatedly within the entire operational volume of the containment vessel;
(ii) an optional degassing stage of the mixing procedure that expels any gaseous phase that has collected above the liquid and solid phases; consisting of possible reaction gasses, vaporized liquids, and/or interstitial gasses from the bulk solid phase; by lowering the piston-like closure and allowing the gasses to escape through a vent;
(iii) a shearing and mixing stage of the mixing operation that breaks up any agglomerated particles and fully and uniformly disperses the solid phase into the liquid phase, wherein the perforated plate is cycled rapidly and repeatedly within the entire operational volume of the combined solid and liquid phases, introducing the optimum level of shear to form a uniform solids/liquids blend; and,
(iv) an expulsion stage of the mixing operation that forces almost all of the mixed material to exit a port in one end of the containment vessel, by continued lowering of the piston-like closure to the end of the vessel
